(19) United States
(12) Patent Application Publication
(10) Pub. No.: US 2024/0049686 A1
(43) Pub. Date: Feb. 15, 2024

(54) Wand Toy for Pets

(71) Applicant: Cassandra Gail Dagostino, Brooklyn, NY (US)

(72) Inventor: Cassandra Gail Dagostino, Brooklyn, NY (US)

(21) Appl. No.: 17/887,187

(22) Filed: Aug. 12, 2022

(51) Int. Cl. A01K 15/02

(52) U.S. Cl. CPC A01K 15/025

(57) ABSTRACT

A wand toy for pets includes a body having a central long axis and a specific peripheral outer shape, and a cushioned handle at the base of the body, having a specific peripheral outer shape, and a hollow head at the top of the body, having a diameter larger than the diameter of the body and having a specific peripheral outer shape, and a tail made of a grouping of long flexible strands disposed through the head and secured thereto, the free end of each multi-strand grouping protruding from the head, and a fitted covering having the specific peripheral outer shape of the body, handle, and head.

### BACKGROUND OF THE INVENTION

### 1. Field of the Invention

This invention is in the technical area of pet supplies, and pertains more particularly to interactive toys for domestic pets.

### 2. Description of Related Art

In the art of pet supplies, more particularly pet toys, many different types of wands have been developed to promote interaction between the animal and the toy. One problem with existing toy wands is that they each appeal to only one of the animal's heightened senses that make them such efficient predators in nature. Many of these wands focus solely on visual teasing for pets, disregarding the reliance these animals, including but not limited to cats, ferrets, and birds, have on smell, hearing, and touch.

Another limitation to existing wands is they are often made from plastic and wire. Plastic and wire prohibit the animal from expressing their instinctive need to scratch and chew. Plastic and wire also present dangers if consumed by pets. Therefore what is clearly needed is a toy wand that appeals simultaneously to pets' varying senses and is made of natural, non-hazardous materials.

### BRIEF SUMMARY OF THE INVENTION

In one embodiment of the invention a wand toy for pets is provided, comprising a body having a central long axis and a specific peripheral outer shape, and a cushioned handle at the base of the body, having a specific peripheral outer shape, and a hollow head at the top of the body, having a diameter larger than the diameter of the body and having a specific peripheral outer shape, and a tail made of a grouping of long flexible strands disposed through the head and secured thereto, the free end of each multi-strand grouping protruding from the head, and a fitted covering having the specific peripheral outer shape of the body, handle, and head.

Also in one embodiment the head is filled with natural material to form rattle sound effects. Also in one embodiment the grouping of long flexible strands is made from natural, penetrable material. Also in one embodiment the fitted covering is made from natural, penetrable material.

### BRIEF DESCRIPTION OF THE SEVERAL VIEWS OF THE DRAWINGS

FIG. 1 is a perspective view of a wand toy for pets according to an embodiment of the present invention.

FIG. 2 is a detail section view of the wand toy of FIG. 1 according to an embodiment of the present invention.

FIG. 3 is a perspective view of the wand toy of FIG. 1 according to a further embodiment of the present invention.

FIG. 4A is a view of a cat swatting the wand toy of FIG. 1 according to a further embodiment of the present invention.

FIG. 4B is a view of a cat scratching the wand toy of FIG. 1 according to a further embodiment of the present invention.

FIG. 4C is a view of a cat chewing the wand toy of FIG. 1 according to a further embodiment of the present invention.

### DETAILED DESCRIPTION OF THE INVENTION

The inventor provides a unique toy for pets that enables simultaneous engagement of their instinctive behaviors at a more robust level. The present invention is described in enabling detail in the following examples, which may represent more than one embodiment of the present invention.

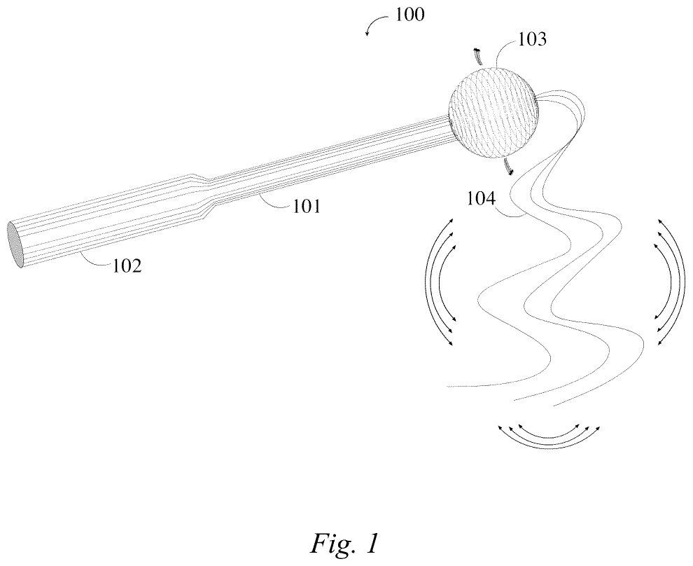

FIG. 1 is a perspective view of a wand toy 100 according to an embodiment of the present invention. Wand toy 100 is in this example an interactive wand toy that produces commercially for the consumer market. Wand toy 100 has in this embodiment a cylindrical body 101 having a central long axis. Body 101 may be hollow or solid and may be made from a variety of materials such as wood or bamboo. In a preferred embodiment, body 101 is a solid wood body allowing greater material thickness to form in the specified areas.

In this embodiment, body 101 maintains one diameter throughout. However, the example of maintaining one diameter throughout should not be construed as a limitation of the invention. Other characterizations for body 101 are possible and may be considered according to one or more embodiments of the present invention. The inventor chooses to use a cylinder of one diameter in a preferred embodiment because of the equal weight distribution. In one embodiment of the invention, a spiral, zig zag or any other shape with a long central axis may be imitated without departing from the spirit and scope of the present invention.

Wand toy 100 has in this embodiment a cylindrical cushioned handle 102 at the base of body 101. Handle 102 may be hollow or solid and may be made from a variety of materials such as wood, bamboo, or foam. Handle 102 in this embodiment maintains one diameter throughout at a diameter larger than body 101. However, the example of maintaining one diameter throughout and being at a diameter larger than body 101 should not be construed as a limitation of the invention. Other characterizations for handle 102 are possible and may be considered according to one or more embodiments of the present invention. The inventor chooses to use a cylinder of one diameter in a preferred embodiment because of the even grip it allows for the human hand holding the toy. In one embodiment of the invention, a cushioned conical handle or cushioned handle with finger indentations may be imitated without departing from the spirit and scope of the present invention.

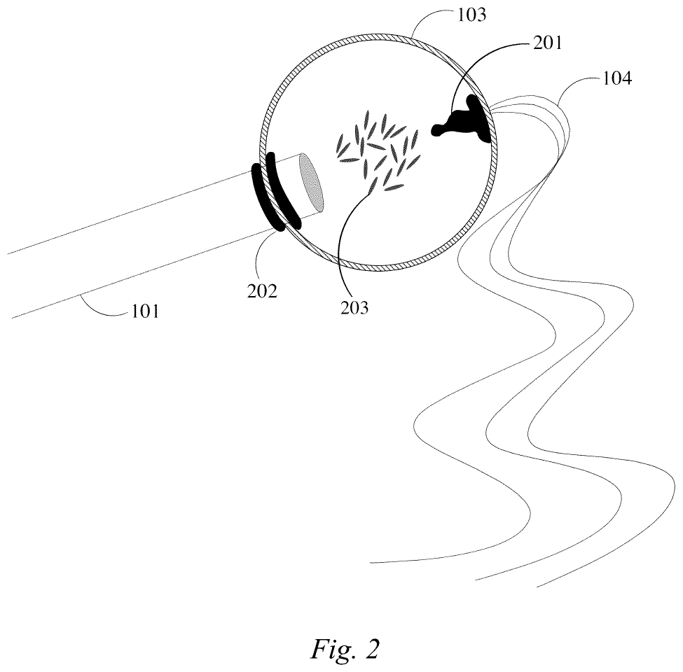

In this embodiment, wand toy 100 has a hollow spherical head 103 at the top of body 101, with head 103 having a diameter larger than the diameter of body 101. However the example of a spherical imitation should not be construed as a limitation of the invention. Other characterizations of head 103 are possible and may be considered according to one or more embodiments of the present invention. In one embodiment of the invention, a fish, bird, butterfly or any other prey which attracts domestic pets may be imitated without departing from the spirit and scope of the present invention. Head 103 may be made from a variety of materials such as plastic, wood, bamboo, or foam. In a preferred embodiment, head 103 is hollow and is filled with a natural material. In this view, the interior of head 103 is not entirely visible and is described in more detail later in this specification relative to FIG. 2 in section view.

Wand toy 100 includes, in this example, a tail 104 disposed through head 103. Tail 104 is characterized by one or more grouping of flexible, yet resilient, strands of cotton or similar natural material. In this example, there is one grouping of three strands. Each grouping of strands is held to a unique protrusion length from head 103 so that simulation of the strands moving is easily achieved when toy 100 is held by the human. In this view, the assembly of tail 104 within the interior of head 103 is not entirely visible and is described in more detail later in this specification relative to FIG. 2 in section view.

FIG. 2 is FIG. 2 is a detail section view of wand toy 100 of FIG. 1. viewed within the hollow interior of head 103 in FIG. 1 according to an embodiment of the present invention. Wand toy 100 includes tail 104 protruding from head 103 as mentioned further above and that is visible in this sectioned detail view.

In this example, tail 104 is disposed strategically through an opening in the wall of head 103 and is secured in place by a knot 201 tied in the individual groupings of flexible strands. In this example the strands are grouped as a set of three. Knot 201 serves as a stop preventing unintended pullout of tail 104 from head 103, thereby reinforcing the structure of wand toy 100. The opening within the head body is kept much smaller than the diameter of the knot, but can stretch according to material properties to accommodate the knot when the wand toy is assembled.

In one embodiment, tail 104 may further be secured by knots tied into the strand groupings that are strategically disposed to abut against the outer surface of the head as an extra positioning measure to prevent tail 104 from encroaching into the interior of head 103 in the hollow embodiment.

In this example, head 103 is secured to body 101 via an adhesive 202 disposed strategically at an opening in the wall of head 103. Adhesive 202 is applied to an opening that is provided through head 103 where body 101 is inserted. The opening within the head body is kept to the approximate diameter of body 101. Adhesive 202 is applied within the hollow head body and abut against the outer surface of the head as an extra positioning measure to prevent body 101 from encroaching into the interior of head 103 or falling out of the interior of head 103. In one embodiment, head 103 may be further secured to body 101 by washers and screws or other fastening materials.

In this embodiment, body 101 and knot 201 do not touch each other within head 103. A strategic space is left within the interior of head 103 between body 101 and knot 201. This is done to form ample movability across the entire diameter of head 103 for a natural material 203. In a preferred embodiment, head 103 is hollow and is filled with material 203 to form rattle sound effects. Material 203 may be composed from a variety of materials such as rice, salt, sand or clay.

In this embodiment, the remaining volume of head 103 is not entirely filled by material 203. A strategic amount of material 203 is used by determining a quantity of material 203 great enough to make rattle sound effects at a generally acceptable volume level. This quantity of material 203 must be balanced against the remaining area of space within head 103 to allow for unrestricted movement of material 203. When wand toy 100 is shaken, material 203 hits the interior walls of head 103, producing the desired rattle sound effects.

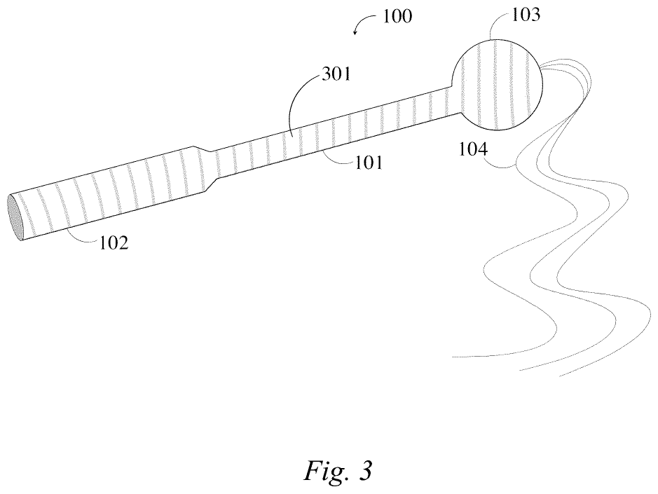

FIG. 3 is a perspective view of wand toy 100 of FIG. 1 according to a further embodiment of the present invention. Wand toy 100 has in this embodiment a fitted covering 301 made of tightly secured, penetrable, and natural materials which in many embodiments has a vibrant color and design. Fitted covering 301 is made to be of a size to fit wand toy 100, or many wands of this approximate size, and is assembled around the length of the wand toy. Fitted covering 301 may be continuous, or it may have an interface where the covering may be joined when fitted to the wand toy.

Fitted covering 301 may be made of any one of a variety of penetrable natural, nontoxic materials that are desirable for pet scratching, such as cotton, wool, hemp, jute, flax, bamboo, rattan or any other suitable natural material, and may have any one of many known protective materials applied to protect against physical damage. Designs and colors may be applied in many different ways. Similarly, the flexible strands of tail 104 may be of any one of a variety of natural, nontoxic materials, such as cotton, wool, or jute. In another embodiment the covering may itself be made of a stretch fabric, and such a covering may be quickly mounted or unmounted by stretching the fabric over the wand to place or remove it from the wand as needed.

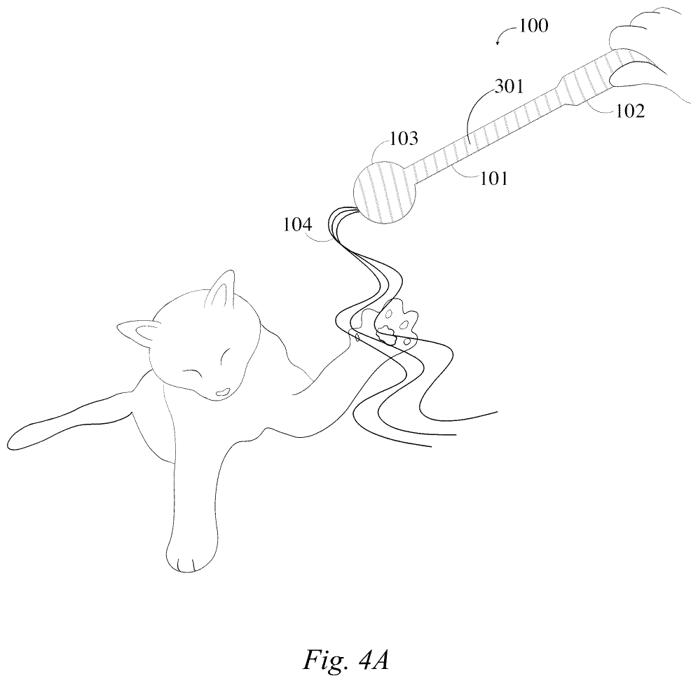

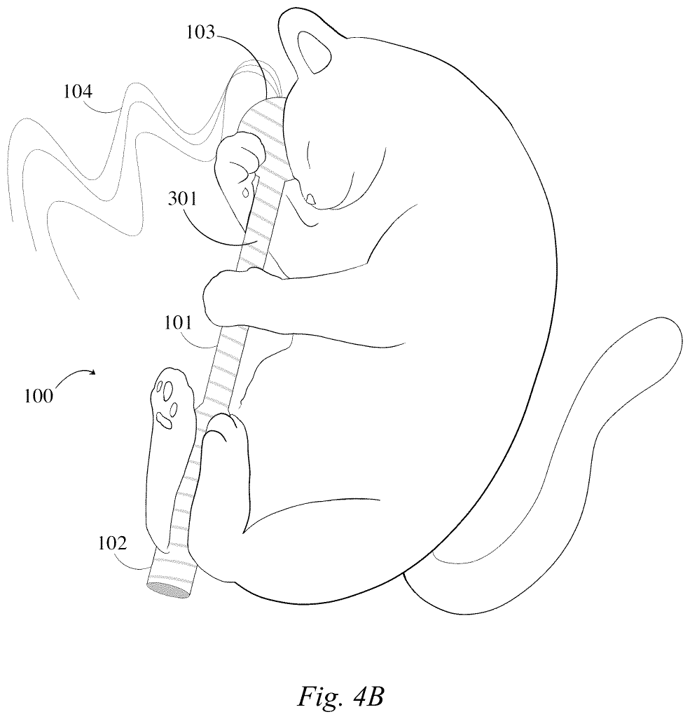

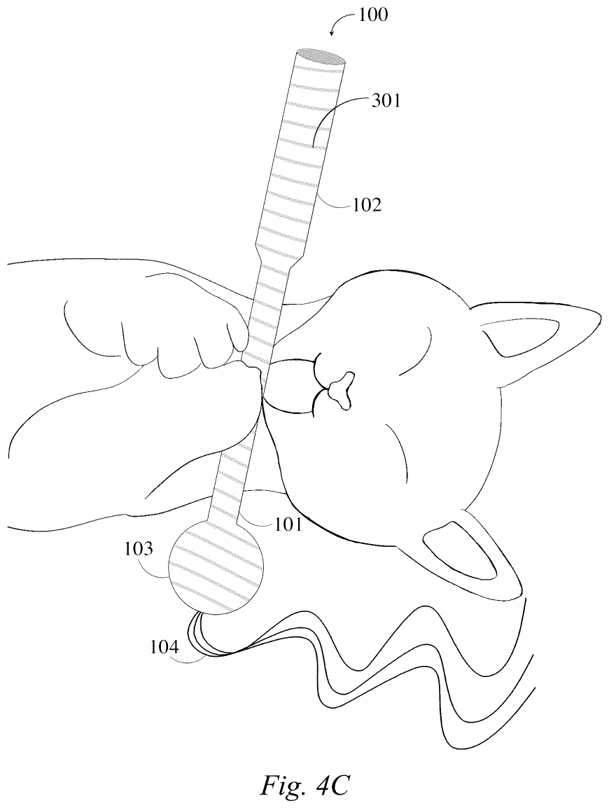

FIG. 4A is a view of a human holding the wand toy 100 of FIG. 4 featuring fitted covering 301 and a cat playfully attacking wand toy 100 according to an embodiment of the present invention. Many wand toys are commercially available in differing sizes and designs, and a person may choose and purchase a wand toy suitable to their interests. Many of these wands focus solely on visual teasing for pets, disregarding the reliance these animals have on smell, hearing, and touch. It can be seen in FIG. 4A that the features of wand toy 100 simultaneously attract a combination of the cat's senses and quickly entices an animal to play. In this embodiment, the visual movement of the flexible strands of tail 104, the rattle sounds of material 203 within head 103, and the natural odors emitted by the material used for tail 104 and fitted covering 301 create multisensory engagement, the particular enhancement to which the present invention pertains.

FIG. 4B is a view of a cat laying on its side scratching the wand toy 100 of FIG. 4 featuring fitted covering 301 according to an embodiment of the present invention. Many commercially available wand toys are often made from impenetrable materials such as plastic. These firm materials are not suitable for pet scratching, a sense they rely on to play, to express emotions, to mark objects with their scent, and to remove the dead part of their nails. In this embodiment, fitted covering 301 is made of tightly secured, penetrable materials such as cotton or jute. The permeable nature of these materials allow pet claws to enter them, scratch them and cling to them without causing destruction, therefore allowing pets to successfully play and scratch, again enhancing multisensory activity.

FIG. 4C is a view of a cat chewing on wand toy 100 of FIG. 4 featuring fitted covering 301 according to an embodiment of the present invention. Many commercially available wand toys are made of materials such as plastic, wire and small metal bells that present dangers if consumed by pets. This prevents pets from safely tasting and chewing on the toy, a common activity and sense used by most pets. In this embodiment, fitted covering 301 and tail 104 are made of natural non-toxic materials that will not harm the pet if fragments are accidentally consumed during chewing or natural wear from playing with the toy. One object of the present invention is to provide a toy that is safe to chew on and enables multisensory play. Many embodiments described are equally applicable to other variations of wand toy 100.

It will be apparent to one with skill in the art that the wand toy of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many variations made in the descriptions without departing from the spirit and scope of the present invention.

What is claimed is:

1. A wand toy for pets, comprising:
a body having a central long axis and a specific peripheral outer shape; and
a cushioned handle at the base of the body, having a specific peripheral outer shape; and
a hollow head at the top of the body, having a diameter larger than the diameter of the body and having a specific peripheral outer shape; and
a tail made of a grouping of long flexible strands disposed through the head and secured thereto, the free end of each multi-strand grouping protruding from the head; and
a fitted covering having the specific peripheral outer shape of the body, handle, and head.

2. The wand toy of claim 1, wherein the head is filled with natural material to form rattle sound effects.

3. The wand toy of claim 1, wherein the grouping of long flexible strands is made from natural, penetrable material.

4. The wand toy of claim 1, wherein the fitted covering is made from natural, penetrable material.
